(19) United States
(12) Patent Application Publication
(10) Pub. No.: US 2019/0114934 A1
(43) Pub. Date: Apr. 18, 2019

(54) SYSTEM AND METHOD FOR EVALUATING ACTIONS PERFORMED TO ACHIEVE COMMUNICATIONS

(71) Applicant: HITACHI, LTD., Tokyo (JP)

(72) Inventors: Yasuhiro Asa, Tokyo (JP); Hiroki Sato, Tokyo (JP); Toshinori Miyoshi, Tokyo (JP); Takashi Numata, Tokyo (JP); Miaomei Lei, Tokyo (JP)

(73) Assignee: HITACHI, LTD., Tokyo (JP)

(21) Appl. No.: 15/912,833

(22) Filed: Mar. 6, 2018

(30) Foreign Application Priority Data
Oct. 18, 2017 (JP) 2017-202182

(51) Int. Cl. G09B 5/00; G09B 19/00

(52) U.S. Cl. CPC G09B 5/00; G09B 19/00

(57) ABSTRACT

A system for evaluating actions that a plurality of target objects performs to achieve communication, the system comprising at least one computer, the at least one computer is configured to: obtain a plurality of signals used for calculating a plurality of state values for evaluating an internal state of a target object in a case where the target object performed the action, from the plurality of target objects; calculate a state feature amount made up of the plurality of state values using the plurality of signals; and generate display information on the basis of the state feature amount, the display information for displaying a positional relationship of the internal state of each of the plurality of target objects in an evaluation space for visually illustrating a similarity of the internal state of the each of the plurality of target objects.

### CLAIM OF PRIORITY

The present application claims priority from Japanese patent application JP 2017-202182 filed on Oct. 18, 2017, the content of which is hereby incorporated by reference into this application.

### BACKGROUND OF THE INVENTION

The present invention relates to a technique of assisting training of communication via action performed on the basis of an estimation result of a mind state of a person.

In order to form a favorable personal relationship, interpersonal communication ability (empathetic communication ability) to empathize with a counterpart is essential.

Here, the interpersonal communication indicates estimating a mind state of a counterpart to communicate intention, feelings, and thought by performing actions on the basis of an estimation result. An Action mean behaviors exhibiting language, look, gestures, and the like. Moreover, the empathetic communication means communication performed under a mind state the same as or similar to that of a counterpart. For example, a behavior that a person feels sad when a counterpart is feeling sad and a person laughs when a counterpart is laughing is an empathetic communication.

Since it is possible to recognize a physical and mental change of a counterpart via a daily interpersonal communication, the interpersonal communication can be utilized for preventing illness or the like in a medical field. Moreover, in a field of utilizing an artificial intelligence (AI) like a communication robot, it is preferable for the AI to have high interpersonal communication ability in order to achieve coexistence with humans.

As described above, in order to perform the empathetic communication, it is necessary to estimate a mind state of a counterpart. However, if the counterpart is a stranger or a person having different sensibility, it is difficult to estimate the mind state of the counterpart. Therefore, it is important to perform training for performing an empathetic communication with various counterparts and assisting the training.

In order to perform training for the empathetic communication and assisting the training, it is effective to present information indicating a mind state of a counterpart and the relationship of mutual mind states (for example, see WO2014/091766).

WO2014/091766 discloses that “an evaluation apparatus evaluates a relationship between test subjects in communications between a plurality of test subjects. A nonverbal information measurement unit observes nonverbal information of a plurality of test subjects, respectively, and generates first signals, which are chronological signals of quantified nonverbal information, for the test subjects, respectively. A waveform analysis unit generates second signals, which are values related to the characteristics of the rhythm of nonverbal information of the test subjects, respectively, on the basis of the first signals obtained for the test subjects, respectively. A relationship evaluation unit generates a third signal (S3), which is an indicator showing a mental state related to the relationship between the test subjects, on the basis of the relative relationship between the plurality of second signals that correspond to the plurality of test subjects, respectively”.

### SUMMARY OF THE INVENTION

In the technique disclosed in WO2014/091766, mind states of multiple persons such as empathy or a sense of trust on the basis of a relative relationship between rhythm relationship amount obtained by executing statistical processing or the like using non-verbal information. However, WO2014/091766 does not disclose a detailed method for evaluating mind states of each person.

It is not possible to grasp a specific relationship of mind states between a subject person and a communication counterpart just by displaying indices such as numerical values indicating mind states of multiple persons. Due to this, a user cannot determine which action is to be performed to enhance a degree of empathy with the communication counterpart. Therefore, it is difficult to apply the conventional technique of WO2014/091766 to communication training.

The present invention realizes a system and a method for providing information useful for performing action training for obtaining empathetic communication ability.

The present invention can be appreciated by the description which follows in conjunction with the following figures, wherein: a system for evaluating action that a plurality of target objects performs to achieve communication, the system comprising at least one computer, the computer includes an arithmetic unit, a storage device coupled to the arithmetic unit, and an interface coupled to the arithmetic unit. The at least one computer is configured to obtain a plurality of signals used for calculating a plurality of state values for evaluating an internal state of a target object in a case where the target object performed the action, from the plurality of target objects; calculate a state feature amount made up of the plurality of state values using the signals; and generate display information based on the state features amount, the display information for displaying a positional relationship of internal states of the plurality of target objects in an evaluation space for visually illustrating a similarity of the internal states of the plurality of target objects.

According to an aspect of the present invention, it is possible to learn actions for realizing a favorable communication by visually checking similarity of an internal state of a target person who performs actions. Other objects, configurations, and effects than the above become apparent from the following description of the embodiments.

### BRIEF DESCRIPTION OF THE DRAWINGS

The present invention can be appreciated by the description which follows in conjunction with the following figures, wherein:

FIG. 1 is a diagram illustrating a configuration example of a communication training system of Embodiment 1,

FIG. 2 is a diagram illustrating an example of a data structure of biosignal management information of Embodiment 1,

FIG. 3 is a diagram illustrating an example of a data structure of state feature amount management information of Embodiment 1,

FIG. 4 is a diagram illustrating an example of a model of Embodiment 1,

FIG. 5 is a flowchart illustrating an example of processing executed by a computer of Embodiment 1,

FIG. 6 is a diagram illustrating an example of an evaluation screen displayed on a display device of Embodiment 1,

FIG. 7 is a diagram illustrating an example of the evaluation screen displayed on the display device of Embodiment 2,

FIG. 8 is a flowchart illustrating an example of processing executed by the computer of Embodiment 3,

FIG. 9 is a diagram illustrating an example of a screen displayed on the display device of Embodiment 3,

FIG. 10 is a diagram illustrating an example of the evaluation screen displayed on the display device of Embodiment 4,

FIG. 11 is a flowchart illustrating an example of processing executed by the computer of Embodiment 5, and

FIG. 12 is a diagram illustrating an example of a screen displayed on the display device of Embodiment 5.

### DETAILED DESCRIPTION OF THE EMBODIMENTS

Hereinafter, an embodiment of the present invention will be described with reference to the appended figures. The present embodiment is merely an example for realizing the present invention but does not limit the technical scope of the present invention.

First, the terms used in the present specification will be described. A communication means communicating intention, feelings, and thought each other via language, letters, and gestures. In the present specification, a behavior of motivating a counterpart who performs communication using language and the like in order to transmit intention and the like is described as an action. An action is a behavior of exhibiting language, look, and gestures, for example.

### Embodiment 1

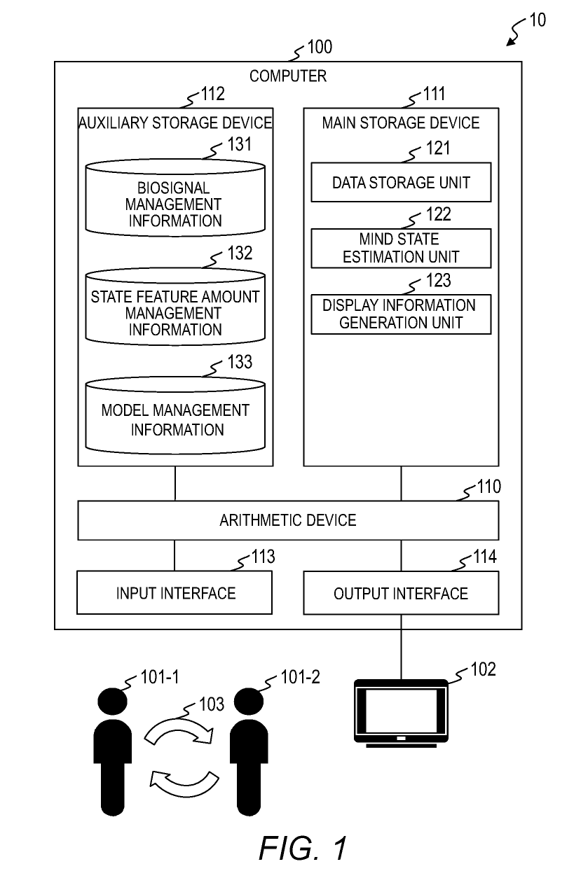

FIG. 1 is a diagram illustrating a configuration example of a communication training system 10 of Embodiment 1.

The communication training system 10 is a system that evaluates actions 103 performed between a plurality of persons 101-1 and 101-2 who perform communication training, and displays information necessary for communication training. The communication training system 10 comprises a computer 100 and a display device 102. In the following description, the persons 101-1 and 101-2 will be also referred to as persons 101 when they are not distinguished from each other.

Evaluation of the action 103 in an empathetic communication is performed based on similarity of a mind state of the person 101 who performed the action 103. This is because the empathetic communication is a communication performed under a situation in which the mind states of a subject person and a counterpart are the same or similar. The person 101 who performs training can obtain empathetic communication ability by learning the actions 103 performed under a similar mind state.

The computer 100 and the display device 102 are connected directly or via a network. The network is a local area network (LAN) and a wide area network (WAN), for example.

Although the present embodiment aims to perform training of a communication between two persons 101, the present embodiment may aim to perform training of a communication between the person 101 and an artificial intelligence (AI). In this case, either one of the persons 101-1 and 101-2 is replaced with an AI. Moreover, the present embodiment may aim to perform training of a communication among three or more persons 101.

The computer 100 obtains a biosignal from the person 101 during a communication and calculates a state feature amount using the biosignal. Here, the state feature amount is made up of state values for evaluating the mind state of the person 101 who performed the actions 103. Moreover, the computer 100 generates display information for displaying information necessary for training the actions 103 including the state feature amount.

The mind state indicates a kind of internal states (parameters) for the person 101 to control the action 103, such as a motivation for performing the action 103 and the reasons for selecting the action 103.

The computer 100 has an arithmetic unit 110, a main storage device 111, an auxiliary storage device 112, an input interface 113, and an output interface 114.

The arithmetic unit 110 is a device such as a processor, a graphics processing unit (GPU), and a field programmable gate array (FPGA) and executes a program stored in the main storage device 111. The arithmetic unit 110 operates as a functional unit (a module) that realizes a specific function by executing processing according to the program. In the following description, when processing is described using a functional unit as a subject, it indicates that the arithmetic unit 110 executes a program for realizing the functional unit.

The main storage device 111 is a memory or the like formed of a nonvolatile storage element such as a read-only memory (ROM) or a volatile storage element such as a random access memory (RAM) and stores a program executed by the arithmetic unit 110 and information used by the program. In the present embodiment, a program is stored in the main storage device 111, and information used by the program is stored in the auxiliary storage device 112. The program stored in the main storage device 111 will be described later.

The auxiliary storage device 112 is a large-capacity and nonvolatile storage device such as a hard disk drive (HDD) and a solid state drive (SSD). The information stored in the auxiliary storage device 112 will be described later.

The program and the information stored in the main storage device 111 may be stored in the auxiliary storage device 112. In this case, the arithmetic unit 110 reads the program and the information from the auxiliary storage device 112 and loads the same into the main storage device 111. Moreover, the arithmetic unit 110 executes the program loaded into the main storage device 111.

The input interface 113 is a device that obtains a biosignal from the person 101. The input interface 113 includes, for example, a microphone, a camera, a depth sensor (a distance sensor), an eye-gaze input sensor, a pulse wave sensor, a body temperature sensor, an electrocardiogram sensor, and a near infrared spectroscopy (NIRS) brain measurement device.

The output interface 114 is a device that outputs various pieces of information and is an interface that transmits screen information according to a predetermined protocol, for example. The output interface 114 may be a network interface.

Here, the program stored in the main storage device 111 and the information stored in the auxiliary storage device 112 will be described.

The auxiliary storage device 112 stores biosignal management information 131, state feature amount management information 132, and model management information 133.

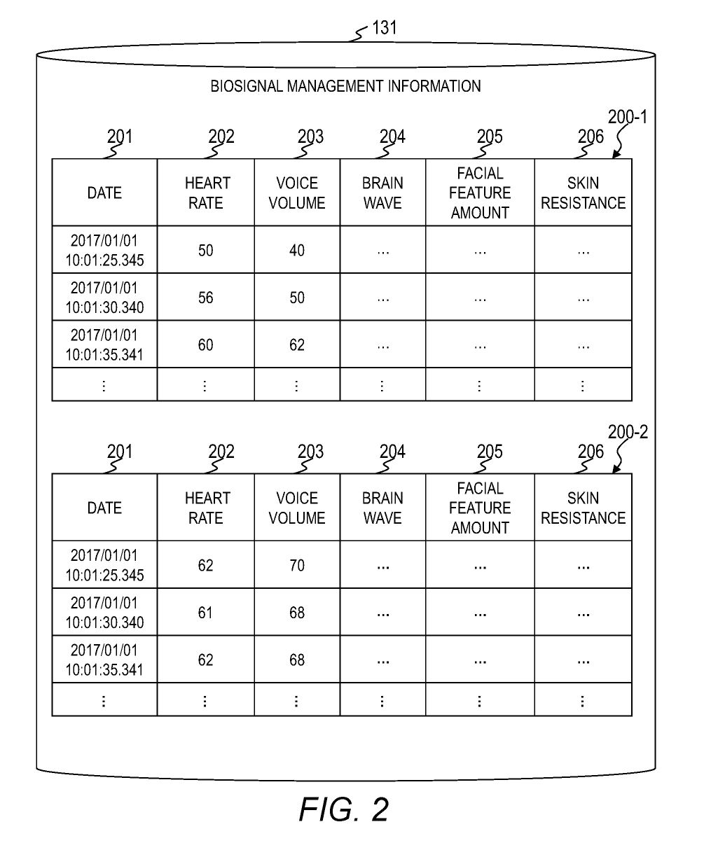

The biosignal management information 131 is information for managing the biosignals obtained from the person 101. The details of the biosignal management information 131 will be described with reference to FIG. 2.

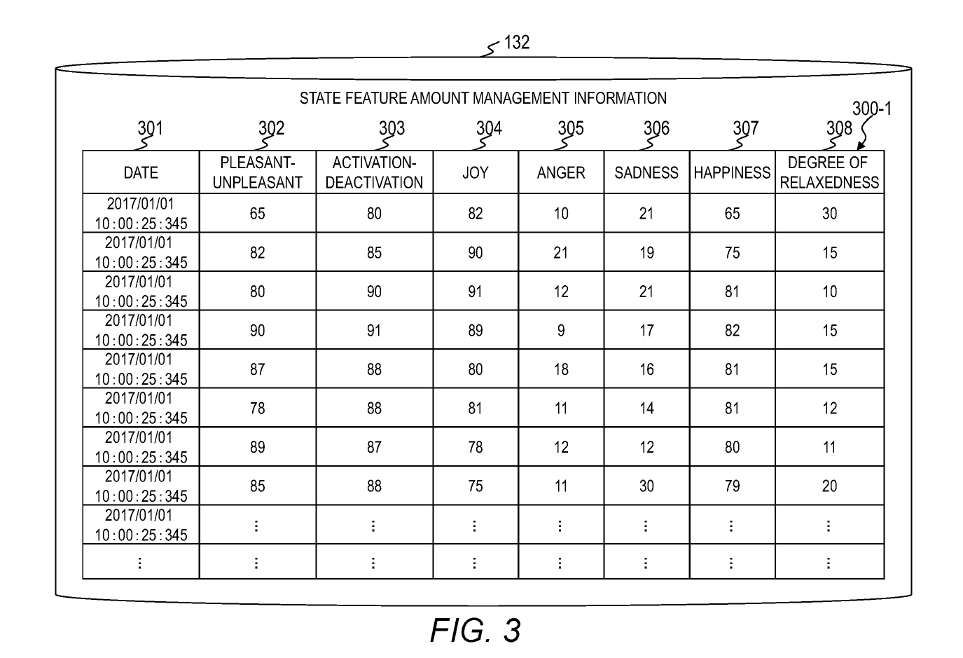

The state feature amount management information 132 is information for managing the state feature amount calculated using the biosignals. The details of the state feature amount management information 132 will be described with reference to FIG. 3.

The model management information 133 is information for managing a model used for visually displaying similarity of a mind state of the person 101 who performed the action 103. Information on the Russell's circumplex model of emotions, for example, is stored in the model management information 133. Information on a plurality of models may be stored in the model management information 133. In this case, the person 101 selects a model to be used.

The main storage device 111 stores a program for realizing a data storage unit 121, a mind state estimation unit 122, and a display information generation unit 123.

The data storage unit 121 stores the biosignals of the person 101 obtained via the input interface 113 in the auxiliary storage device 112. Specifically, the data storage unit 121 stores the biosignals of the person 101 in the biosignal management information 131.

The mind state estimation unit 122 estimates the mind state of the person 101. Specifically, the mind state estimation unit 122 calculates a state feature amount that characterizes the mind state using the biosignals stored in the biosignal management information 131 and stores the calculated state feature amount in the state feature amount management information 132. Moreover, the mind state estimation unit 122 calculates a degree of empathy indicating similarity of the mind state of the person 101 on the basis of the state feature amount.

The display information generation unit 123 generates display information for displaying information necessary for communication training, such as a positional relationship of a mind state in an evaluation space for visually displaying the similarity of a mind state of the person 101. Here, the evaluation space managed on the basis of the model management information 133 is a coordinate space in which coordinate axes corresponding to the state values forming the state feature amount are defined.

Although the computer 100 is illustrated as a physical computer in FIG. 1, the computer 100 may be a virtual computer. Moreover, as for the respective functional units (modules) included in a computer, a plurality of functional units may be integrated into one functional unit, and one functional unit may be divided into a plurality of functional units for respective functions.

FIG. 2 is a diagram illustrating an example of a data structure of the biosignal management information 131 of Embodiment 1.

The biosignal management information 131 includes management tables 200. Each of the management tables stores time-series data of the biosignals of respective persons 101. The biosignal management information 131 illustrated in FIG. 2 includes a management table 200-1 that stores biosignals of the person 101-1 and a management table 200-2 that stores biosignals of the person 101-2. Identification information of the person 101 is assigned to the each of the management tables 200.

A management table 200 includes entries made up of a date 201, a heart rate 202, a voice volume 203, a brain wave 204, a facial feature amount 205, and a skin resistance 206. One entry is present for one timestamp. Entries are stored in the management table 200 in the order of date.

The date 201 is a field that stores the date (timestamp) on which a biosignal was measured. The heart rate 202, the voice volume 203, the brain wave 204, the facial feature amount 205, and the skin resistance 206 are fields that store values of biosignals.

In the present embodiment, it is assumed that a heart rate, a voice volume, a brain wave, look, and a skin resistance are obtained as biosignals. The biosignals are examples only and are not limited thereto.

Here, a method of updating the biosignal management information 131 of the present embodiment will be described.

The data storage unit 121 of the computer 100 obtains biosignals from the person 101 via the input interface 113 periodically. It is assumed that the biosignal includes a timestamp. Moreover, it is assumed that identification information of the person 101 is assigned to the biosignal.

In the present invention, a timing of obtaining the biosignal is not particularly limited. For example, the biosignal may be obtained when an event occurs. Moreover, the timings of obtaining the biosignals from the respective persons 101 may be the same or may be different. In the present embodiment, it is assumed that the timings of obtaining the biosignals from the respective persons 101 are the same.

The data storage unit 121 searches the management table 200 corresponding to the identification information of the person 101. In a case where the management table 200 corresponding to the identification information of the person 101 is not present, the data storage unit 121 generates a new management table 200.

The data storage unit 121 adds an entry to the management table 200 and sets a timestamp to the date 201 of the added entry. Moreover, the data storage unit 121 sets the values of the biosignals to the heart rate 202, the voice volume 203, the brain wave 204, the facial feature amount 205, and the skin resistance 206 of the added entry.

The biosignal management information 131 not only stores the value of the biosignal itself but also may store relative coordinate value or the like of the facial feature amount extracted from the biosignal, such as an image, rather than storing.

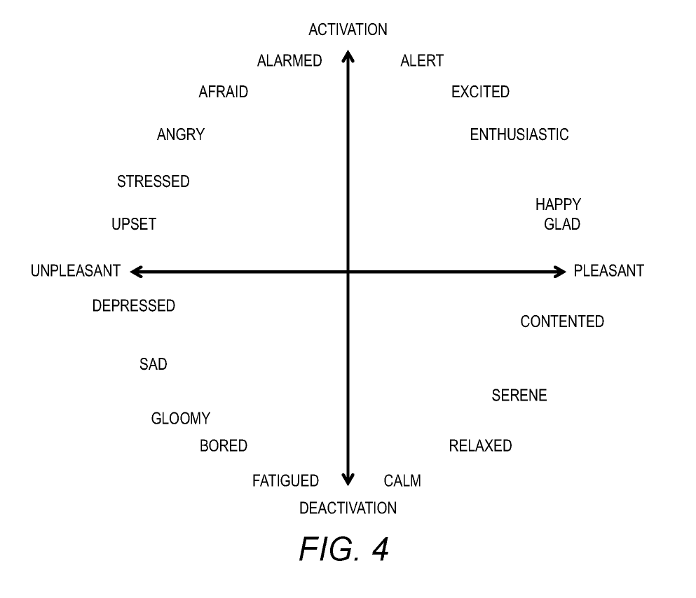

FIG. 3 is a diagram illustrating an example of a data structure of the state feature amount management information 132 of Embodiment 1. FIG. 4 is a diagram illustrating an example of a model of Embodiment 1.

The state feature amount management information 132 includes management tables 300. Each of the management tables 200 stores time-series data of state feature amounts of respective persons 101. The state feature amount management information 132 illustrated in FIG. 3 includes a management table 300-1 that stores time-series data of the state feature amount of the person 101-1. Identification information of the person 101 is assigned to the each of the management tables 300.

A management table 300 includes entries made up of a date 301, a pleasant-unpleasant 302, an activation-deactivation 303, a joy 304, an anger 305, a sadness 306, a happiness 307, and a degree of relaxedness 308. One entry is present for one timestamp.

The date 301 is the same field as the date 201. The pleasant-unpleasant 302, the activation-deactivation 303, the joy 304, the anger 305, the sadness 306, the happiness 307, and the degree of relaxedness 308 are fields that store the state values which are elements forming the state feature amount. The state value is different depending on an evaluation space (a model). In the present embodiment, state values corresponding to each evaluation space are calculated. The state feature amounts illustrated in FIG. 3 are examples only and are not limited thereto.

In the present embodiment, a relationship between a state value and a biosignal is defined using a mathematical formula or the like. The definition information is stored in the model management information 133, for example. All or some state values may be defined as the values of the biosignal itself.

Various methods for estimating a mind state such as feelings and emotions of which the objective evaluation is difficult are proposed. FIG. 4 illustrates the Russell's circumplex model of emotions which is one of models indicating a mind state objectively. In the circumplex model of emotions, all mind states (feelings) are defined to be arranged in a ring form on a two-dimensional plane made up of two axes of “pleasant-unpleasant” and “activation-deactivation”.

In a case where the Russell's circumplex model of emotions is used, it is considered that a pulse wave is correlated with the axis of “pleasant-unpleasant” such that a small pulse wave indicates an unpleasant state and a large pulse wave indicates a pleasant state. Moreover, it is considered that a brain wave is correlated with the axis of “activation-deactivation” such that a larger brain wave indicates a more alert state.

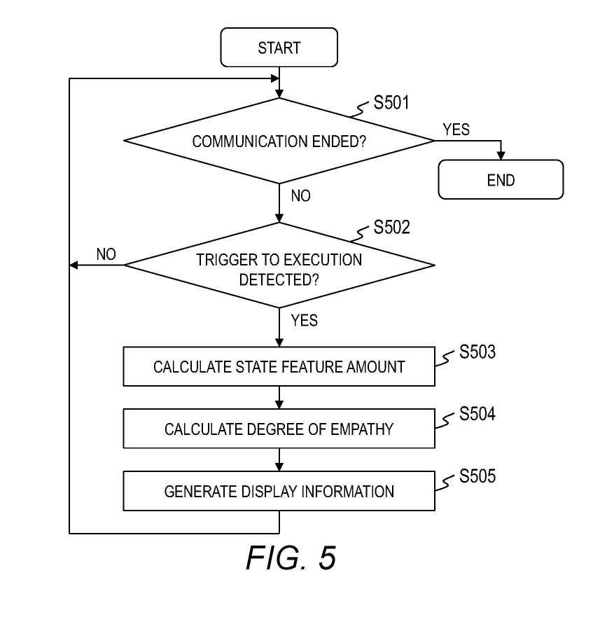

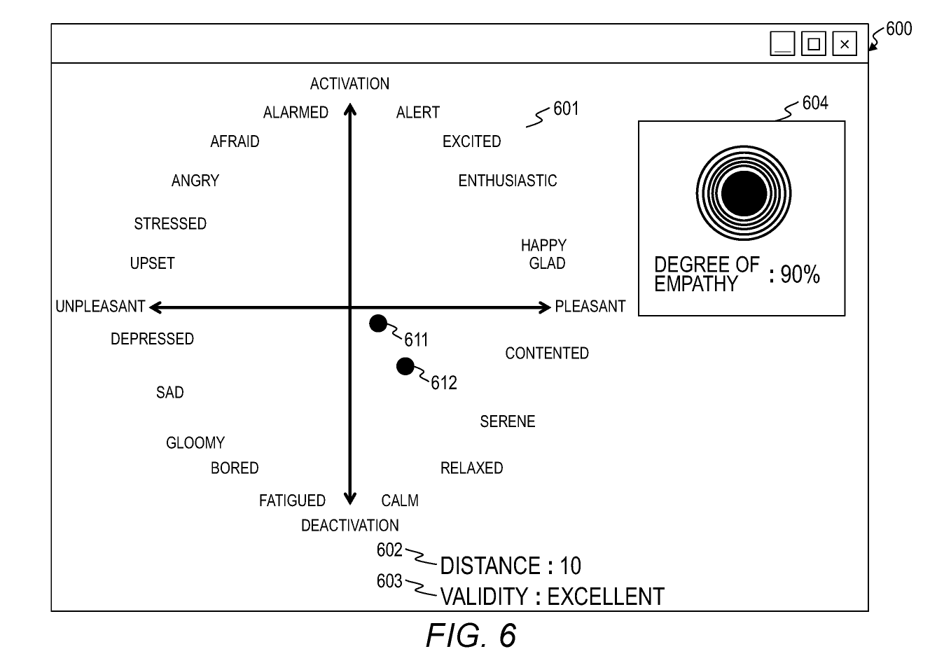

FIG. 5 is a flowchart illustrating an example of processing executed by the computer 100 of Embodiment 1. FIG. 6 is a diagram illustrating an example of an evaluation screen 600 displayed on the display device 102 of Embodiment 1.

The computer 100 starts the following processing when a communication starts. In this example, it is assumed that a model to be used is input to the computer 100. The inputted model may be selected randomly by the computer 100 and may be selected by the person 101 whose action 103 is evaluated.

The mind state estimation unit 122 determines whether a communication has ended (step S501).

For example, the mind state estimation unit 122 determines that the communication has ended in a case where a notification of ending is received. Moreover, the mind state estimation unit 122 monitors the biosignal management information 131 and determines that the communication has ended in a case where the information is not updated for a predetermined period.

In a case where it is determined that the communication has ended, the mind state estimation unit 122 ends the processing.

In a case where it is determined that the communication has not ended, the mind state estimation unit 122 determines whether a trigger to execute a display information generation process has been detected (step S502).

For example, the mind state estimation unit 122 determines that a trigger to execute the display information generation process has been detected in a case where a display request is received. Moreover, the mind state estimation unit 122 may determine that the trigger to execute the display information generation process has been detected in a case where a predetermined execution period has elapsed.

In a case where it is determined that the trigger to execute the display information generation process has not been detected, the mind state estimation unit 122 enters into a waiting state and returns to step S501 after a predetermined period has elapsed.

In a case where it is determined that the trigger to execute the display information generation process has been detected, the mind state estimation unit 122 reads the time-series data of the biosignals from the biosignal management information 131 and calculates the state feature amount using the read time-series data of the biosignals (step S503). Specifically, the following processing is executed.

(1) The mind state estimation unit 122 selects a target management table 200 among the management tables 200 included in the biosignal management information 131. The mind state estimation unit 122 generates a management table 300 corresponding to the target management table 200 in the state feature amount management information 132.

(2) The mind state estimation unit 122 selects a target entry among the entries included in the target management table 200. In the present embodiment, an entry of which the date is the latest is selected as the target entry. The mind state estimation unit 122 adds an entry corresponding to the target entry to the management table 300. The mind state estimation unit 122 sets a timestamp to be stored in the date 201 of the target entry to the date 301 of the added entry.

(3) The mind state estimation unit 122 calculates the state value by substituting the value of the biosignal set to the target entry into the mathematical formula for calculating the state value. The mind state estimation unit 122 sets the calculated state value to the added entry. Basically, the state value associated with the selected model only is calculated. The state values associated with all models may be calculated. In the present embodiment, it is assumed that the state values associated with all models are calculated.

The mind state estimation unit 122 executes the processes (2) to (3) with respect to all entries included in the target management table 200. The mind state estimation unit 122 executes the processes (1) to (3) with respect to all management tables 200.

In the above-described processing, although the state value is calculated using the value (that is, the latest time-series data) of the biosignal of which the timestamp is the latest, other calculation methods may be used.

Variation 1 of Calculation Method

For example, as illustrated in mathematical formula (1), the mind state estimation unit 122 may calculate the state value by taking past state values (a plurality of pieces of time-series data) into consideration. For example, the state value is calculated using transmission time-series data of 30 seconds before from the present time point.

$$\begin{matrix}Formula ( 1 ) & \\ {V}_{m}^{i} ( n ) = {v}_{m}^{i} ( n ) + {\sum }_{j = 1}^{J} {w}_{j} \cdot {V}_{m}^{i} ( n - j ) & ( 1 )\end{matrix}$$

Here, a mathematical formula will be described.

“m” is a suffix for identifying the person 101. “i” is a suffix indicating the type of an element forming the state feature amount (that is, the type of the state value). In the present embodiment, i of “1” indicates “pleasant-unpleasant”, i of “2” indicates “activation-deactivation”, i of “3” indicates “joy”, i of “4” indicates “anger”, i of “5” indicates “sadness”, i of “6” indicates “happiness”, and i of “7” indicates “degree of relaxedness”.

“n” is a suffix indicating the order of a target entry in the management table 200. “j” is a suffix indicating the number of past state values to be taken into consideration (that is, the number of entries). vⁱₘ(n) indicates a state value of an element i set to an n-th entry of the management table 200 corresponding to a person 101-m. More specifically, vⁱ₁(n) indicates a state value of an element i set to an n-th entry of the person 101-1. vⁱ₂(n) indicates a state value of an element i set to an n-th entry of the person 101-2. In the example illustrated in FIG. 2, v²₁(2) is “85”.

“Vⁱₘ(n)” indicates the state value of the element i after correction. “wⱼ” indicates a weight of which the value ranges from 0 to 1. “Vⁱₘ(n−j)” indicates the state value of an element i set to the entry of j entries before, of a target entry. In the present embodiment, the state value of the element i of the target entry is calculated by taking the state feature amounts of J entries before into consideration. Hereinabove, the mathematical formula has been described.

In a case where an analysis process which uses the history of past biosignals is executed rather than real time processing, the mind state estimation unit 122 may calculate the state value corrected by taking a mind state (a future mind state) at a time point earlier than a target time point into consideration at the target time point.

Variation 2 of Calculation Method

As illustrated in mathematical formula (2), the mind state estimation unit 122 may calculate the state value by taking the state values (a plurality of pieces of time-series data) of the communication counterpart into consideration.

$$\begin{matrix}Formula ( 2 ) & \\ {V}_{m}^{i} ( n ) = {v}^{i} ( n ) + {\sum }_{j = 1}^{J} {w}_{j} \cdot {V}_{m}^{i} ( n - j ) + {\sum }_{k = 1}^{K} {w}_{k}^{′} \cdot {V}_{m}^{′ i} ( n - k ) & ( 2 )\end{matrix}$$

“w′ₖ” indicates a weight which ranges from 0 to 1. “V′ⁱₘ(n−k)” indicates the state value of an element i before k entries, of the n-th entry of the management table 300 corresponding to a communication counterpart, corresponding to the target entry.

In a case where it is desired to decrease the influence of the state value of a time point distant from the present time point, the weight may be set such that the larger j, the smaller wⱼ and the larger k, the smaller w′ₖ.

The state value calculated on the basis of mathematical formula (1) or (2) may be stored in a table other than the management table 300.

In the present embodiment, although the state feature amount is calculated in a case where a trigger to execute the display information generation process is detected, the present invention is not limited thereto. The state feature amount may be calculated in a case where the biosignal is obtained. In this way, it is possible to increase the processing speed of the display information generation process. Hereinabove, the process of step S503 has been described.

Next, the mind state estimation unit 122 calculates the degree of empathy on the basis of the state feature amount and the model management information 133 (step S504).

The mind state estimation unit 122 calculates the degree of empathy using mathematical formula (3), for example. L(n) is defined by mathematical formula (4).

$$\begin{matrix}Formula ( 3 ) & \\ E ( n ) = \frac{( L max - L ( n ) )}{L max} \times 100 & ( 3 ) \\ Formula ( 4 ) & \\ L ( n ) = \sqrt{{\sum }_{i = 1}^{I} {( {v}_{1}^{i} ( n ) - {v}_{2}^{i} ( n ) )}^{2}} & ( 4 )\end{matrix}$$

“I” indicates the type of a coordinate axis defined in an evaluation space. For example, in a case where the evaluation space corresponds to the Russell's circumplex model of emotions, I of “1” indicates “pleasant-unpleasant” and I of “2” indicates “activation-deactivation”. “Lmax” indicates the maximum distance. Lmax is set in advance. “E(n)” indicates a degree of empathy at a date corresponding to the n-th row of the management table 200. “L(n)” indicates the Euclid distance of the mind state of the person 101 in the evaluation space at the date corresponding to the n-th row of the management table 200. As illustrated mathematical formula (3), the smaller the distance of the mind state in the evaluation space (that is, the more similar the mind state), the larger the degree of empathy.

The mind state estimation unit 122 may evaluate the validity of the action 103 on the basis of the magnitude of the degree of empathy or the distance. For example, the mind state estimation unit 122 outputs “Perfect” if the distance is smaller than a first threshold, “excellent” if the distance is the first threshold or more and smaller than a second threshold, “good” if the distance is the second threshold or more and smaller than a third threshold, “fair” if the distance is the third threshold or more and smaller than a fourth threshold, and “poor” if the distance is the fourth threshold or more.

Subsequently, the display information generation unit 123 generates display information and outputs the generated display information to the display device 102 (step S505). After that, the computer 100 returns to step S501 and executes similar processing. In step S505, the following processing is executed.

The display information generation unit 123 obtains definition information of an evaluation space from the model management information 133 and generates first display data for displaying a graph plotting the mind state (a state feature amount) in the evaluation space. The first display data is information for displaying a positional relationship of the mind state of the person 101 in the evaluation space. Moreover, the display information generation unit 123 generates second display data for displaying the distance of the mind state and the degree of empathy in the evaluation space.

The display information generation unit 123 outputs the display information including the first display data and the second display data to the display device 102.

The display information generation unit 123 may include third display data for displaying an evaluation result of the validity of the action 103 in the display information. Hereinabove, the process of step S505 has been described.

Here, an example of an evaluation screen 600 displayed on the display device 102 on the basis of the display information will be described with reference to FIG. 6. The evaluation screen 600 includes a graph display region 601, a distance display region 602, a validity display region 603, and a degree-of-empathy display region 604.

The graph display region 601 is a region of displaying a graph indicating a positional relationship of the mind state of the person 101 in the evaluation space. In the graph display region 601 of FIG. 6, a graph plotting the points 611 and 612 in the evaluation space corresponding to the Russell's circumplex model of emotions is displayed. The points 611 and 612 indicate the mind states of the persons 101-1 and 101-2.

The distance display region 602 is a region of displaying the distance of the mind state in the evaluation space. The validity display region 603 is a region of displaying an evaluation result of the validity of the action 103. The degree-of-empathy display region 603 is a region of displaying the degree of empathy.

The calculated degree of empathy and a figure that visually indicates the magnitude of the degree of empathy are displayed in the degree-of-empathy display region 604. In the present embodiment, a circular figure is displayed in the degree-of-empathy display region 604. The magnitude of the degree of empathy is proportional to the magnitude of the circle.

A screen configuration and a method of displaying the evaluation screen 600 illustrated in FIG. 6 are examples only and are not limited thereto.

Although the communication training system of Embodiment 1 is a system for communication between persons 101, one or both of the persons 101 may be artificial intelligence (AI).

In the case of AI, the computer 100 may obtain the values of parameters defined in an algorithm that controls actions instead of the biosignals. Moreover, the computer 100 calculates the internal state of the AI (that is, the mind state of the AI) using the parameter values.

As described above, according to Embodiment 1, the person 101 can grasp the similarity of the mind state between the subject person (a person or an AI) and a counterpart (a person or an AI) in communication as a positional relationship (a distance) in an evaluation space by referring to the evaluation screen 600 displayed on the display device 102. Therefore, the person 101 can intensively learn such an action 103 that the distance of the mind state in the evaluation space decreases. In this way, it is possible to obtain empathetic communication ability efficiently.

### Embodiment 2

An evaluation space presented in Embodiment 2 is different from the evaluation space presented in Embodiment 1.

In Embodiment 1, an evaluation space corresponding to a selected model is used. However, when there are two or more types of biosignals to be used, it may sometimes be difficult to define a relationship between biosignals and respective coordinate axes of the evaluation space. Moreover, when an evaluation space that depends on a model is used, although the degree of empathy may be high in one evaluation space, the degree of empathy may be low in the other evaluation space. Therefore, the determination result of the validity of the action 103 may be different depending on an evaluation space to be used.

Therefore, in Embodiment 2, the computer 100 generates display information using an evaluation space (a distance space) defined by coordinate axes that do not make specific meanings. Here, a distance space indicates a set in which the distance (a distance function) is defined with respect to an arbitrary element included in the set. Hereinafter, a difference between Embodiment 1 and Embodiment 2 will be mainly described.

A system configuration of Embodiment 2 is the same as the system configuration of Embodiment 1. Moreover, a hardware configuration and a software configuration of the computer 100 of Embodiment 2 are the same as those of Embodiment 1.

The processing executed by the computer 100 of Embodiment 2 is partially different from the processing executed by the computer of Embodiment 1.

In step S503, the mind state estimation unit 122 calculates the state values for all models registered in the model management information 133. For example, the mind state estimation unit 122 calculates seven types of state values as illustrated in FIG. 3 from five types of biosignals as illustrated in FIG. 2.

In step S504, the mind state estimation unit 122 calculates the distance of the mind state using a function that inputs a vector which includes all state values as elements of the vector. A mathematical formula illustrated in mathematical formula (4) may be used. However, the target of “I” in mathematical formula (4) is the coordinate axes of all evaluating space. Furthermore, the mind state estimation unit 122 calculates a two-dimensional or three-dimensional space coordinate system from the calculated distance using a known method such as a classical multi-dimensional scaling method or a non-metric multi-dimensional scaling method.

The classical multi-dimensional scaling method will be described briefly. A distance matrix D⁽²⁾ illustrated in mathematical formula (5) is expressed as mathematical formula (7) using a coordinate matrix X illustrated in mathematical formula (6). Here, when the distance matrix D⁽²⁾ is subjected to Young-Householder transformation to perform eigenvalue decomposition, mathematical formula (8) is obtained. Here, mathematical formula (9) can be regarded as coordinate values of an r-dimensional space in which the center of gravity of N points is at the origin. When the larger two eigenvalues A are selected in descending order, the element values of a corresponding eigenvector P are the coordinate values of a two-dimensional space. Moreover, when the larger three eigenvalues A are selected in descending order, the element values of a corresponding eigenvector P are the coordinate values of a three-dimensional space.

$$\begin{matrix}Formula ( 5 ) & \\ {D}^{( 2 )} = ( \begin{matrix}0 & {d}_{12}^{2} & {d}_{13}^{2} & … & {d}_{1 N}^{2} \\ {d}_{21}^{2} & 0 & {d}_{23}^{2} & … & {d}_{2 N}^{2} \\ {d}_{31}^{2} & {d}_{32}^{2} & 0 & … & {d}_{3 N}^{2} \\ ⋮ & ⋮ & ⋮ & 0 & ⋮ \\ {d}_{N 1}^{2} & {d}_{N 2}^{2} & {d}_{N 3}^{2} & … & 0\end{matrix} ) & ( 5 ) \\ Formula ( 6 ) & \\ X = ( {x}_{1} , {x}_{2} , … {x}_{N} ) & ( 6 ) \\ Formula ( 7 ) & \\ {D}^{( 2 )} = diag ( {XX}^{T} ) \cdot ( 1 \cdot {1}^{T} ) - 2 {XX}^{T} + ( 1 \cdot {1}^{T} ) \cdot diag ( {XX}^{T} ) & ( 7 ) \\ Formula ( 8 ) & \\ - \frac{1}{2} ( I - \frac{1 \cdot {1}^{T}}{N} ) {D}^{( 2 )} ( 1 - \frac{1 \cdot {1}^{T}}{N} ) = P ( \begin{matrix}\sqrt{{λ}_{1}} & … & 0 & 0 \\ ⋮ & ⋱ & & ⋮ \\ 0 & … & \sqrt{{λ}_{N - 1}} & 0 \\ 0 & … & 0 & 0\end{matrix} ) ( \begin{matrix}\sqrt{{λ}_{1}} & … & 0 & 0 \\ ⋮ & ⋱ & & ⋮ \\ 0 & … & \sqrt{{λ}_{N - 1}} & 0 \\ 0 & … & 0 & 0\end{matrix} ) {P}^{T} & ( 8 ) \\ Formula ( 9 ) & \\ P ( \begin{matrix}\sqrt{{λ}_{1}} & … & 0 & 0 \\ ⋮ & ⋱ & & ⋮ \\ 0 & … & \sqrt{{λ}_{N - 1}} & 0 \\ 0 & … & 0 & 0\end{matrix} ) & ( 9 )\end{matrix}$$

The processes of steps S501, S502, and S505 of Embodiment 2 are the same as the processes of Embodiment 1.

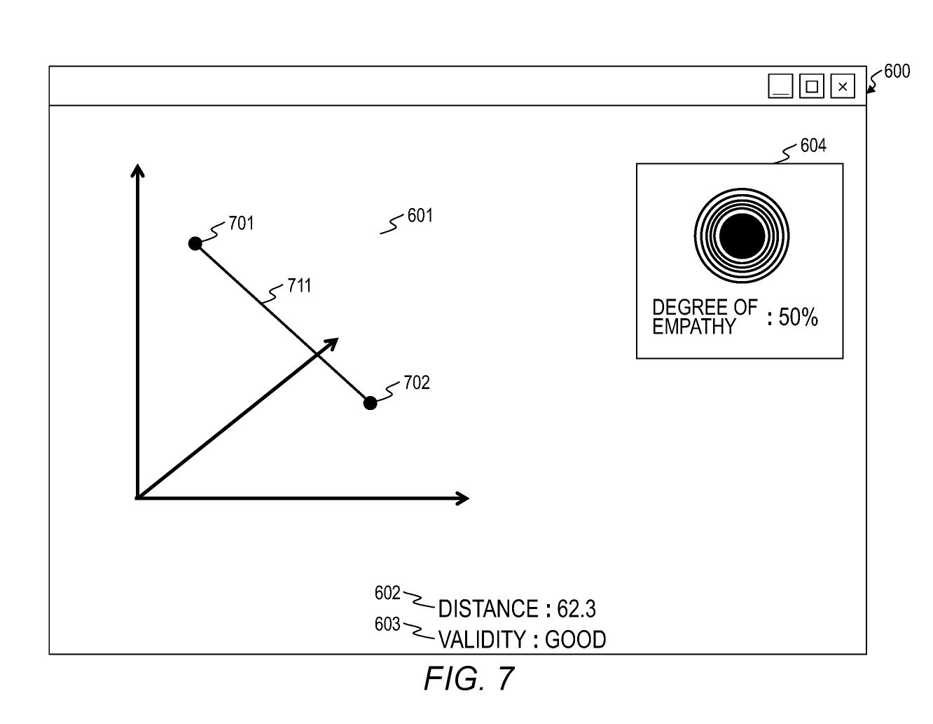

FIG. 7 is a diagram illustrating an example of the evaluation screen 600 displayed on the display device 102 of Embodiment 2.

In the graph display region 601 of the evaluation screen 600, points 701 and 702 indicating the mind states are plotted in a distance space so that a distance relationship is maintained. A three-dimensional Euclid distance is defined in the distance space. An edge 711 indicates the distance of the mind states.

According to Embodiment 2, the same advantages as those of Embodiment 1 are obtained. Moreover, in Embodiment 2, since it is possible to display a positional relationship of mind states on an evaluation space that does not depend on a model, it is possible to decrease variation in a determination result of the validity of the action 103 depending on a model.

### Embodiment 3

Embodiment 3 is different from Embodiment 1 in that stability is displayed in addition to the degree of empathy. Hereinafter, a difference between Embodiments 1 and 2 will be mainly described.

A system configuration of Embodiment 3 is the same as the system configuration of Embodiment 1. Moreover, a hardware configuration and a software configuration of the computer 100 of Embodiment 3 are the same as those of Embodiment 1.

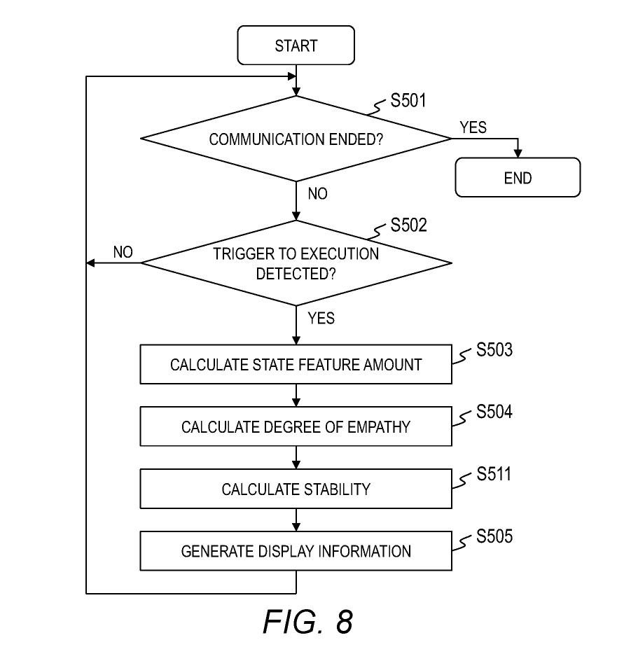

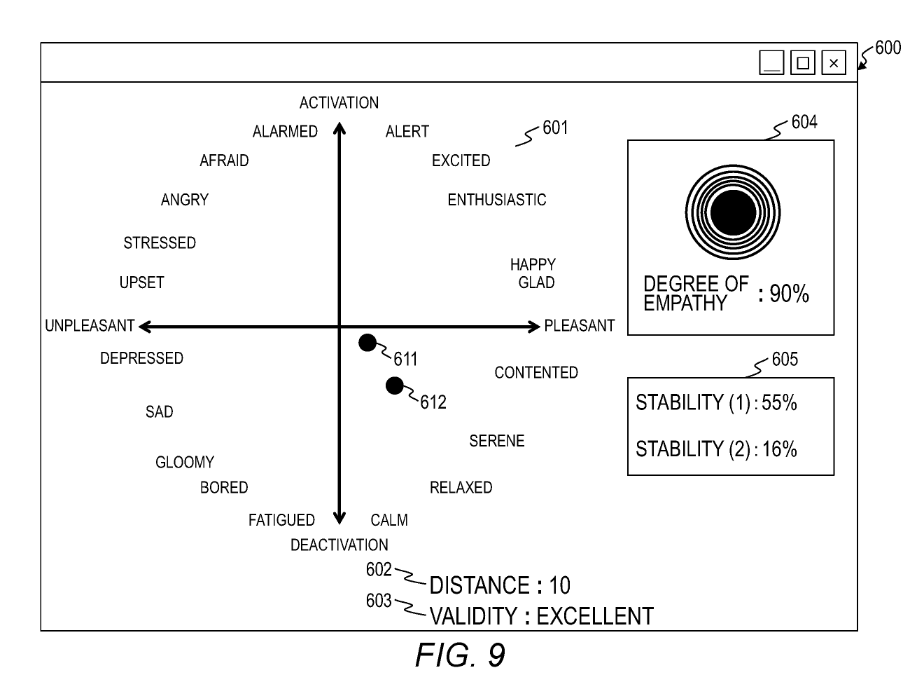

The processing executed by the computer 100 of Embodiment 3 is partially different from the processing executed by the computer of Embodiment 1. FIG. 8 is a flowchart illustrating an example of processing executed by the computer 100 of Embodiment 3. FIG. 9 is a diagram illustrating an example of a screen displayed on the display device 102 of Embodiment 3.

The processes of steps S501 to S504 are the same as those of Embodiment 1.

After the process of step S504 is executed, the mind state estimation unit 122 calculates stability (step S511). Specifically, the following processing is executed.

(1) The mind state estimation unit 122 selects a target management table 300 among the management tables 300 included in the state feature amount management information 132.

(2) The mind state estimation unit 122 selects a target entry among entries included in the target management table 300. In the present embodiment, an arbitrary number of target entries are selected in descending order of dates.

(3) The mind state estimation unit 122 calculates a stability Sₘ(n) on the basis of an arbitrary mathematical formula. For example, the stability is calculated using mathematical formula (10) or (11). “vⁱₘ_{_}ₐᵥₑ(n)” is defined by mathematical formula (12).

$$\begin{matrix}Formula ( 10 ) & \\ {S}_{m} ( n ) = \sqrt{{\sum }_{i = 1}^{I} {( {v}_{m}^{i} ( n ) - {v}_{m}^{i} ( n - 1 ) )}^{2}} & ( 10 ) \\ Formula ( 11 ) & \\ {S}_{m} ( n ) = \sqrt{{\sum }_{i = 1}^{I} {( {v}_{m}^{i} ( n ) - {v}_{m \_ ave}^{i} )}^{2}} & ( 11 ) \\ Formula ( 12 ) & \\ {v}_{m \_ ave}^{i} = \frac{1}{L} {\sum }_{j = 0}^{I} {v}_{m}^{i} ( n - j ) & ( 12 )\end{matrix}$$

Subsequently, the display information generation unit 123 generates display information and outputs the generated display information to the display device 102 (step S505). In step S505, fourth display data for displaying the stability is generated.

As illustrated in FIG. 9, a stability display region 605 is further included in the evaluation screen 600 of Embodiment 3. The stability display region 605 is a region for displaying the stability calculated in step S511.

The stability is an index indicating a change amount in the mind state. Therefore, a small stability indicates that the action 103 is stable. Therefore, according to Embodiment 3, the person 101 can learn the action 103 for realizing a stable communication since the person 101 can determine whether the communication is stable or not by referring to the stability.

### Embodiment 4

Embodiment 4 is different from Embodiment 1 in that a change over time in the mind state is displayed on the evaluation screen 600. Hereinafter, a difference between Embodiments 1 and 4 will be mainly described.

A system configuration of Embodiment 4 is the same as the system configuration of Embodiment 1. Moreover, a hardware configuration and a software configuration of the computer 100 of Embodiment 4 are the same as those of Embodiment 1.

In Embodiment 4, a learning target person 101 is selected in advance in the computer 100. In this example, the person 101-1 is selected as the learning target person 101.

The processing executed by the computer 100 of Embodiment 4 is partially different from the processing executed by the computer 100. The processes of steps S501 to S504 are the same as those of Embodiment 1.

In step S505, the mind state estimation unit 122 obtains time-series data of the state feature amounts indicating the past mind states of the person 101-2 from the state feature amount management information 132. The mind state estimation unit 122 generates fifth display data for displaying a change in the mind state in the evaluation space using the obtained time-series data.

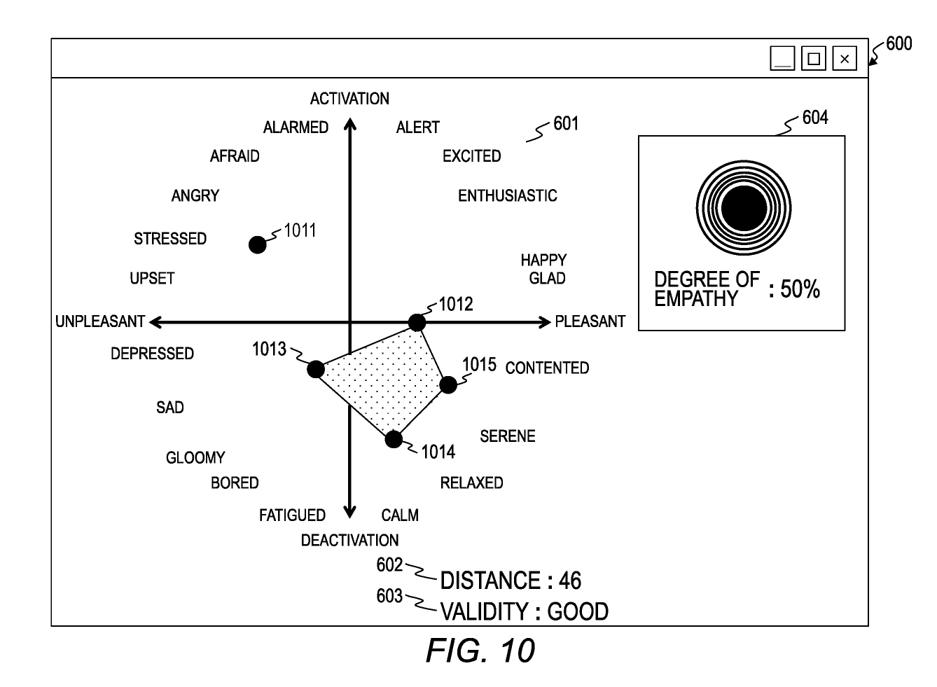

FIG. 10 is a diagram illustrating an example of the evaluation screen 600 displayed on the display device 102 of Embodiment 4.

A point 1011 indicating the present mind state of the person 101-1 and a point 1012 indicating the present mind state of the person 101-2 are plotted in the evaluation space displayed in the graph display region 601 of the evaluation screen 600. Moreover, points 1013, 1014, and 1015 indicating the past mind states of the person 101-2 are plotted in the evaluation space. Paths indicating changes over time in the mind state, an area surrounded by the paths, and the like may be displayed in a highlighted manner so that a change in the mind state can be understood.

In a case where the validity of the action 103 is evaluated, an average of the distances between the point 1012 and the points 1013, 1014, and 1015 may be used.

In the present embodiment, although a change over time in the mind state of the person 101-2 is presented to the person 101-1, a change over time in the mind state of the person 101-1 may be presented to the person 101-2.

According to Embodiment 4, the person 101-1 can learn the action 103 by taking a change in the mind state into consideration by referring to the evaluation screen 600 illustrated in FIG. 10. For example, in a case where the pulse wave of the person 101-2 increases with time, it is possible to enhance the degree of empathy by performing an action 103 corresponding to a mind state that is more vivid and excited than the present mind state of the person 101-2. Moreover, in a case where the change over time in the mind state of the person 101-2 is large, it can be understood that a stable communication is not achieved.

### Embodiment 5

Embodiment 5 is different from Embodiment 1 in that the computer 100 predicts a future mind state of the person 101 and displays a prediction result to the person 101. Hereinafter, a difference between Embodiments 1 and 5 will be mainly described.

A system configuration of Embodiment 5 is the same as the system configuration of Embodiment 1. Moreover, a hardware configuration and a software configuration of the computer 100 of Embodiment 5 are the same as those of Embodiment 1.

In Embodiment 5, a learning target person 101 is selected in advance in the computer 100. In this example, the person 101-1 is selected as the learning target person 101.

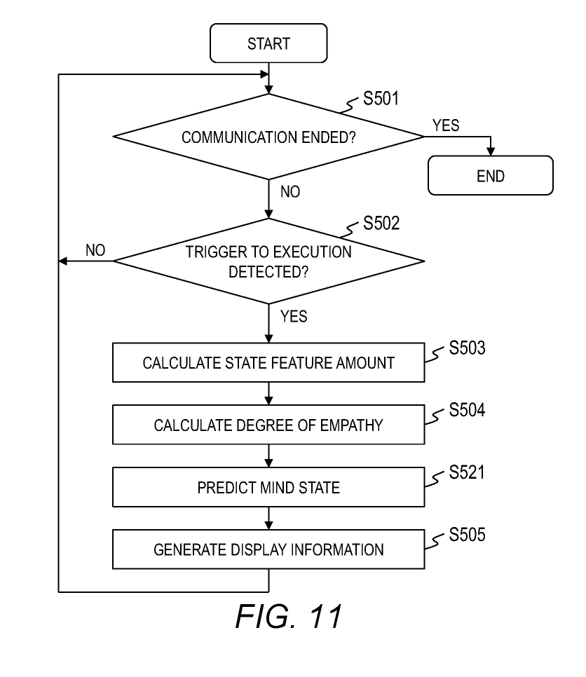

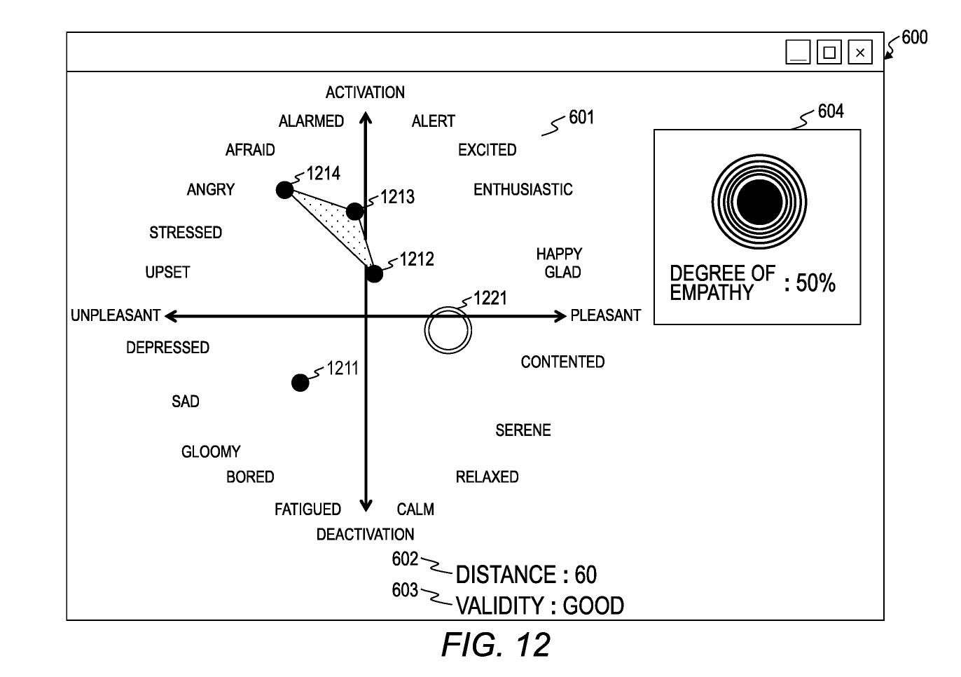

The processing executed by the computer 100 of Embodiment 5 is partially different from the processing executed by the computer of Embodiment 1. FIG. 11 is a flowchart illustrating an example of processing executed by the computer 100 of Embodiment 5. FIG. 12 is a diagram illustrating an example of a screen displayed on the display device 102 of Embodiment 5.

The processes of steps S501 to S504 are the same as those of Embodiment 1.

After the process of step S504 is executed, the mind state estimation unit 122 predicts a mind state of the person 101-2 (step S521).

For example, the mind state estimation unit 122 predicts the mind state of the person 101-2 using such a linear prediction method as illustrated in mathematical formula (13).

$$\begin{matrix}Formula ( 13 ) & \\ {V}_{2}^{i} ( n + 1 ) = {\sum }_{j = 0}^{J} {α}_{j} \cdot {V}_{2}^{i} ( n - j ) & ( 13 )\end{matrix}$$

Here, “vⁱ₂(n+1)” is a predicted value of the mind state of the person 101-2 after the elapse of a next obtaining period. “αⱼ” is an expectation coefficient and satisfies mathematical formula (14).

$$\begin{matrix}Formula ( 14 ) & \\ {\sum }_{j = 0}^{J} {α}_{j} = 1 & ( 14 )\end{matrix}$$

Subsequently, the display information generation unit 123 generates display information and outputs the generated display information to the display device 102 (step S505). In step S505, sixth display data for displaying a prediction result of the mind state of the person 101-2 is generated.

As illustrated in FIG. 12, a point 1211 indicating the present mind state of the person 101-1 and a point 1212 indicating the present mind state of the person 101-2 are plotted in the evaluation space displayed in the graph display region 601 of the evaluation screen 600. Moreover, points 1213 and 1214 indicating the past mind states of the person 101-2 are plotted in the evaluation space. In the present embodiment, it is assumed that the mind state of the person 101-2 changes sequentially from the point 1214 to the points 1213 and 1212.

A prediction region 1221 which is a prediction result of the future mind state of the person 101-2 is displayed in the graph display region 601.

According to Embodiment 5, the person 101 can select a valid action 103 by referring to the prediction result in advance.

The present invention is not limited to the above embodiment and includes various modification examples. In addition, for example, the configurations of the above embodiment are described in detail so as to describe the present invention comprehensibly. The present invention is not necessarily limited to the embodiment that is provided with all of the configurations described. In addition, a part of each configuration of the embodiment may be removed, substituted, or added to other configurations.

A part or the entirety of each of the above configurations, functions, processing units, processing means, and the like may be realized by hardware, such as by designing integrated circuits therefor. In addition, the present invention can be realized by program codes of software that realizes the functions of the embodiment. In this case, a storage medium on which the program codes are recorded is provided to a computer, and a CPU that the computer is provided with reads the program codes stored on the storage medium. In this case, the program codes read from the storage medium realize the functions of the above embodiment, and the program codes and the storage medium storing the program codes constitute the present invention. Examples of such a storage medium used for supplying program codes include a flexible disk, a CD-ROM, a DVD-ROM, a hard disk, a solid state drive (SSD), an optical disc, a magneto-optical disc, a CD-R, a magnetic tape, a non-volatile memory card, and a ROM.

The program codes that realize the functions written in the present embodiment can be implemented by a wide range of programming and scripting languages such as assembler, C/C++, Perl, shell scripts, PHP, and Java (registered trademark).

It may also be possible that the program codes of the software that realizes the functions of the embodiment are stored on storing means such as a hard disk or a memory of the computer or on a storage medium such as a CD-RW or a CD-R by distributing the program codes through a network and that the CPU that the computer is provided with reads and executes the program codes stored on the storing means or on the storage medium.

In the above embodiment, only control lines and information lines that are considered as necessary for description are illustrated, and all the control lines and information lines of a product are not necessarily illustrated. All of the configurations of the embodiment may be connected to each other.

What is claimed is:

1. A system for evaluating actions that a plurality of target objects performs to achieve communication, the system comprising at least one computer,
the at least one computer including an arithmetic unit, a storage device coupled to the arithmetic unit, and an interface coupled to the arithmetic unit, wherein
the at least one computer is configured to:
obtain a plurality of signals used for calculating a plurality of state values for evaluating an internal state of a target object in a case where the target object performed the action, from the plurality of target objects;
calculate a state feature amount made up of the plurality of state values using the plurality of signals; and
generate display information on the basis of the state feature amount, the display information for displaying a positional relationship of the internal state of each of the plurality of target objects in an evaluation space for visually illustrating a similarity of the internal state of the each of the plurality of target objects.

2. The system according to claim 1, wherein
the at least one computer is configured to:
store model management information for managing a model which is information on an evaluation space in which a plurality of coordinate axes are defined, each of the plurality of coordinates axes corresponds to each of the plurality of state values;
calculate a state feature amount made up of state values corresponding to a plurality of coordinate axes of a first evaluation space on the basis of the model management information;
calculate a distance between the internal state of the each of the plurality of target objects in the first evaluation space; and
generate the display information including the distance.

3. The system according to claim 1, wherein
the at least one computer is configured to:
store model management information for managing a model which is information on an evaluation space in which a plurality of coordinate axes are defined, each of the plurality of coordinate axes corresponds to each of the plurality of state values;
calculate the state feature amount made up of the plurality of state values corresponding to the plurality of coordinate axes of the evaluation space managed by the model management information on the basis of the model management information;
calculate a distance between the internal state of the each of the plurality of target objects using a function that inputs the state feature amount as a vector;
calculate a distance space using the distance as the evaluation space; and
generate the display information including the distance.

4. The system according to claim 2, wherein
the at least one computer is configured to:
calculate a degree of empathy indicating a similarity of the internal state of the each of the plurality of target objects on the basis of the distance; and
generate the display information including the degree of empathy.

5. The system according to claim 2, wherein
the at least one computer is configured to:
store a calculation history of the state feature amount;
calculate a change amount in the state feature amount of the target object as a stability on the basis of the calculation history of the state feature amount; and
generate the display information including the stability.

6. The system according to claim 2, wherein
the at least one computer is configured to:
determine whether the action is valid on the basis of the distance; and
generate the display information including the determination result.

7. The system according to claim 2, wherein
the at least one computer is configured to:
store a calculation history of the state feature amount;
predict a state feature amount of the target object when a next action is performed on the basis of the calculation history of the state feature amount; and
generate the display information including the prediction result.

8. A method for evaluating actions that a plurality of target objects performs to achieve communication, the method being executed by a system including at least one computer, the at least one computer including:
an arithmetic unit,
a storage device coupled to the arithmetic unit, and
an interface coupled to the arithmetic unit,
wherein the method includes:
a first step of obtaining, by the at least one computer, a plurality of signals used for calculating a plurality of state values for evaluating an internal state of a target object in a case where the target object performed the action from the plurality of target objects;
a second step of calculating, by the at least one computer, a state feature amount made up of the plurality of state values using the plurality of signals; and
a third step of generating, by the at least one computer, display information on the basis of the state feature amount, the display information for displaying a positional relationship of the internal state of each of the plurality of target objects in an evaluation space for visually illustrating a similarity of the internal state of the each of the plurality of target objects.

9. The method according to claim 8, wherein
the at least one computer stores model management information for managing a model which is information on an evaluation space in which a plurality of coordinate axes are defined, each of the plurality of coordinate axes corresponds to each of the plurality of state values,
the second step includes:
a step of calculating, by the at least one computer, a state feature amount made up of state values corresponding to a plurality of coordinate axes of a first evaluation space on the basis of the model management information; and
a step of calculating, by the at least one computer a distance between the internal state of the each of the plurality of target objects in the first evaluation space, and
the third step includes a step of generating, by the at least one computer, the display information including the distance.

10. The method according to claim 8, wherein
store model management information for managing a model which is information on an evaluation space in which a plurality of coordinate axes are defined, each of the plurality of coordinate axes corresponds to the state values,
the second step includes:
a step of calculating, by the at least one computer, the state feature amount made up of the plurality of state values corresponding to the plurality of coordinate axes of the evaluation space managed by the model management information on the basis of the model management information;
a step of calculating, by the at least one computer, a distance between the internal state of the each of the plurality of target objects using a function that inputs the state feature amount as a vector; and
a step of calculating, by the at least one computer, a distance space using the distance as the evaluation space, and
the third step includes a step of generating, by the at least one computer, the display information including the distance.

11. The method according to claim 9, further including a step of calculating, by the at least one computer, a degree of empathy indicating a similarity of the internal state of the each of the plurality of target objects on the basis of the distance, wherein
the third step includes a step of generating, by the at least one computer, the display information including the degree of empathy.

12. The method according to claim 9, wherein
the at least one computer stores a calculation history of the state feature amount,
the method further includes a step of calculating, by the at least one computer, a change amount in the state feature amount of the target object as a stability on the basis of the calculation history of the state feature amount, and
the third step includes a step of generating, by the at least one computer, the display information including the stability.

13. The method according to claim 9, further including a step of determining, by the at least one computer, whether the action is valid on the basis of the distance, wherein
the third step includes a step of generating, by the at least one computer, the display information including the determination result.

14. The method according to claim 9, wherein
the at least one computer stores a calculation history of the state feature amount,
the method further includes a step of predicting, by the at least one computer, a state feature amount of the target object when a next action is performed on the basis of the calculation history of the state feature amount, and
the third step includes a step of generating, by the at least one computer the display information including the prediction result.
